(19) United States
(12) Patent Application Publication
(10) Pub. No.: US 2015/0170228 A1
(43) Pub. Date: Jun. 18, 2015

(54) CUSTOMER FEEDBACK SYSTEM

(71) Applicant: State Farm Mutual Automobile Insurance Company, Bloomington, IL (US)

(72) Inventors: Debra Lynn Wheeler, Stanford, IL (US); Samuel Harold Howard, Bloomington, IL (US); Mark Christopher Russell, Normal, IL (US); Desirae Lee Schwertel, Alpharetta, GA (US); Arthur Conrad Jackson, JR., Mahomet, IL (US); Nancy Kathryn Armstrong, Towanda, IL (US)

(73) Assignee: State Farm Mutual Automobile Insurance Company, Bloomington, IL (US)

(21) Appl. No.: 14/109,337

(22) Filed: Dec. 17, 2013

(51) Int. Cl. G06Q 30/02; G06Q 50/00

(52) U.S. Cl. CPC G06Q 30/0282; G06Q 50/01

(57) ABSTRACT

The system and method allows an organization to receive different types of customer feedback, process the feedback, store the feedback, determine feedback that is related (such as multiple feedback items that are from the same customer, discuss the same product, service, or event), analyze the related feedback, and initiate actions based on the received customer feedback. The method and system may initiate actions based on whether the analyzed, related feedback exceeds a threshold. For example, the method and system may initiate customer recovery efforts if too many negative feedback items are received from the same customer. The method and system may assign weights to different types of feedback before completing the threshold calculation.

### FIELD OF TECHNOLOGY

The present disclosure generally relates to a system and a method for an organization to receive and use different types of customer feedback and, more particularly, to a system that can help an organization receive and react to different types of customer feedback.

### BACKGROUND

Organizations solicit and receive feedback from customers about their products and services. Organizations try to react to this feedback by improving their products and services to keep their customers satisfied. However, this can be challenging for an organization because of the many differences in customer feedback. Customer feedback may be solicited or unsolicited. Also, customer feedback may occur via different methods, such as surveys, phone calls, emails, online, etc. Furthermore, different types of customer feedback may have different benefits and different drawbacks. As a result, managing and reacting to customer feedback is a challenge for organizations.

### SUMMARY

A method for integrating multiple feedback items from one or more customers to improve an organization that engages with one or more customers including receiving a first feedback item from a first customer via a first channel, wherein the first feedback item is a customer survey, wherein the first channel is an email; receiving a second feedback item from a second customer via a second channel, wherein the second feedback item is a complaint, wherein the second channel is a phone call; receiving a third feedback item from a third customer via a third channel, wherein the third feedback item is a message, wherein the third channel is a social media website; processing the first feedback item; storing the first feedback item in a feedback database; processing the second feedback item; storing the second feedback item in the feedback database; processing the third feedback item; storing the third feedback item in the feedback database; determining the first feedback item, second feedback item, and third feedback item are related based on a common trait of all three feedback items; and initiating an action based on the related first feedback item, second feedback item, and third feedback item.

In an embodiment, a computer system including a processor; and a program memory storing executable instructions that when executed by the processor cause the computer system to receive a first feedback item from a first customer via a first channel; receive a second feedback item from a second customer via a second channel; process the first feedback item; process the second feedback item; determine the first feedback item and second feedback item are related; and initiate an action based on the related first feedback item and second feedback item.

In another embodiment, a method for integrating multiple feedback items to improve an organization including receiving a first feedback item from a first customer via a first channel; receiving a second feedback item from a second customer via a second channel; processing the first feedback item; processing the second feedback item; determining the first feedback item and second feedback item are related; and initiating an action based on the related first feedback item and second feedback item.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram of an example of an organization receiving feedback from customers, according to an embodiment.

FIG. 2 is a diagram of an example of feedback transmission within an organization without using the customer feedback system.

FIG. 3 is a diagram of an example of feedback transmission within an organization using the customer feedback system, according to an embodiment.

FIG. 4 is a block diagram of an example of a customer feedback system implementation, according to an embodiment.

FIG. 5 is a diagram of an example of survey feedback procurement for an organization, according to an embodiment.

FIG. 6 is a diagram of an example of direct feedback procurement for an organization, according to an embodiment.

FIG. 7 is a diagram of an example of social media feedback procurement for an organization, according to an embodiment.

FIG. 8 is a diagram of an example of customer feedback system output transmission, according to an embodiment.

FIG. 9 is a diagram of an example of customer feedback system output generation, according to an embodiment.

FIG. 10 is a diagram of an example of a customer feedback process, according to an embodiment.

FIG. 11A is a flow diagram of a customer feedback system initiating an action based on multiple feedback items, according to an embodiment.

FIG. 11B is a flow diagram of the customer feedback system initiating an action based on multiple feedback items, according to an embodiment.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is No intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

In today's environment, organizations seek to achieve current and future goals and objectives by improving the organization. Organizations can improve by enhancing any number of components of the organization, such as their products, services, marketing, decision-making, internal and external policies and/or procedures, etc. Customer feedback is a useful tool for determining how an organization is performing, what needs to be improved, and how to make the needed improvements.

Customer feedback allows an organization to determine customer sentiment about the organization and its various components. By determining customer sentiment, an organization can identify underperforming components, which components to improve, and how to improve the identified components. By addressing underperforming components correctly, the organization can improve as a whole efficiently and further achieve its goals and objectives.

Customer feedback can be secured and characterized in different fashions. First, customer feedback can be categorized as solicited or unsolicited feedback. Second, customer feedback can be characterized as structured versus unstructured feedback. Different types of feedback have different benefits and drawbacks.

One example of structured feedback is a customer survey generated by an organization. The survey may contain questions designed to elicit responses from the customer about specific components of the organization. Some benefits of structured feedback include its utility for projecting business results. However, structured feedback lacks deep insights into customer sentiment.

A couple examples of unstructured feedback are direct feedback (e.g. customer complaints) and social media website feedback. Direct feedback can include customer complaints, customer compliments, neutral comments by customers, or other types of feedback from customers or other parties engaging with an organization. Direct feedback can include phone calls, letters, emails, or other communications from customers about a component of an organization, such as a product, service, and/or marketing materials. Social media feedback can include blogs, microblogs with a character limit, messages, preference indications, pictures, and/or other communications from a customer on a social media website or other forum. These communications can also refer to a component of an organization, such as its products, services, and/or marketing materials. Unstructured feedback tends to be unsolicited. Unstructured feedback can provide deep insights into customer sentiment. However, unstructured feedback typically isn't projectable.

Because of the benefits and drawbacks of structured and unstructured feedback, a more comprehensive view of customers can be obtained by integrating both types of feedback. Integration would provide both deep insights into customer sentiment and projectable data. A better comprehensive view may improve the richness and accuracy of the determined customer sentiment. This improved determination may lead to better decision-making for an organization, thereby fueling an organization to achieve more goals at a faster pace. Thus, integrating structured and unstructured feedback can add value to an organization. Currently, a tool or method for integrating these different types of feedback does not exist. The customer feedback system addresses this issue.

### Customer Feedback System Overview

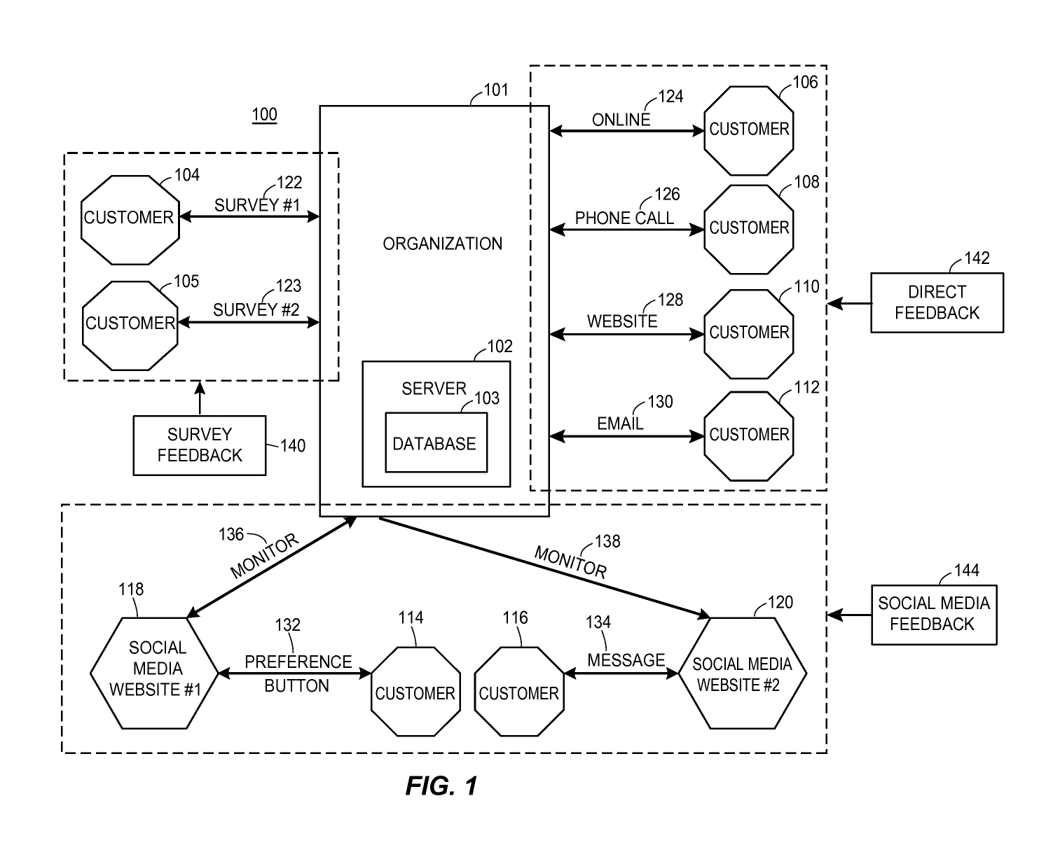

FIG. 1 is a diagram of an organization feedback environment 100, according to an embodiment. In the displayed embodiment, organization feedback environment 100 includes an organization 101 which engages with one or more customers 104, 105, 106, 108, 110, 112, 114, and 116. In the organization feedback environment 100, organization 101 gathers and receives customer feedback from one or more customers 104, 105, 106, 108, 110, 112, 114, and 116. The organization 101 provides products and/or services to one or more customers 104, 105, 106, 108, 110, 112, 114, and 116. The organization 101 may also provide marketing materials about the organization's products and/or services to one or more customers 104, 105, 106, 108, 110, 112, 114, and 116.

In some embodiments, the organization 101 may include one or more people, such as employees, partners, members, owners, directors, officers, shareholders, or other constituents of an organization 101. The organization 101 may be a legal entity, such as a partnership, corporation, sole proprietorship, or a limited liability company. In some cases, the organization 101 is a business. The organization 101 may include one or more departments, divisions, entities, sectors, units, businesses, etc. In some embodiments, the organization 101 is an insurance company. The products of the organization 101 may include insurance policies while the services of the organization 101 may include insurance policy claim reimbursement.

The marketing materials of the organization 101 may include advertisements on television, radio, the Internet, billboards, signs, and/or other mediums. These marketing materials may be displayed in periodicals, magazines, newspapers, or other written communications. Additionally, the organization 101 may have marketing materials displayed in stadiums, arenas, buildings, or other venues or places. Furthermore, marketing materials of the organization 101 may also include sponsorships, naming rights, logos, and/or other items. The marketing materials of the organization 101 may be transmitted via email, text message, online message, microblog, blog, or some other communication. Moreover, the organization 101 may have advertisements available on other items via other mediums. In some embodiments, advertisements may refer to an advertisement campaign for an insurance policy.

In FIG. 1, the organization 101 includes a server 102. The server 102 may be used to implement the customer feedback system for the organization 101. The customer feedback system may receive, format, organize, store, process, update, modify, and/or analyze the feedback received from one or more customers 104, 105, 106, 108, 110, 112, 114, and 116 about the organization 101.

In the displayed embodiment in FIG. 1, the server 102 is located at the organization 101. Alternatively, the server 102 is remotely located, that is, the server 102 is not located at the organization 101. The server 102 may be hosted by an entity other than organization 101. The server 102 may include more than one server. In this case, the multiple servers 102 may work together to provide a platform that supports the customer feedback system for the organization 101.

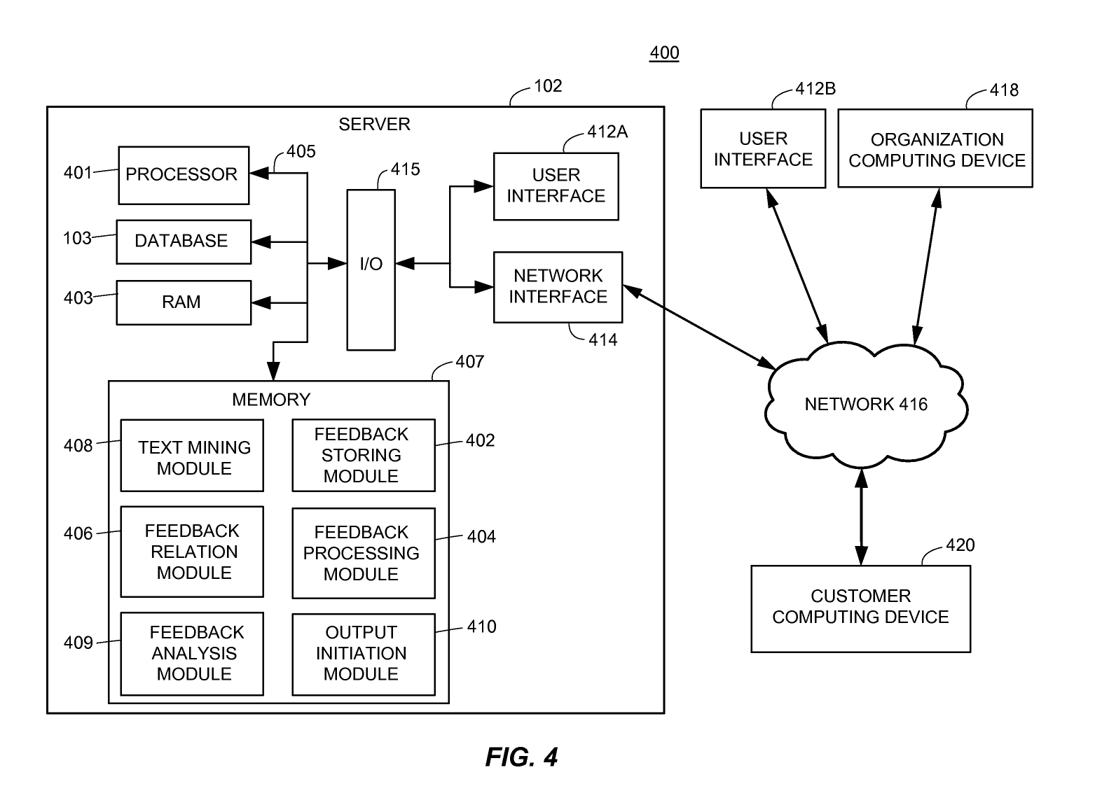

The server 102 may include a database 103. Database 103 may be used to store feedback about the organization 101 received from one or more customers 104, 105, 106, 108, 110, 112, 114, and 116. In FIG. 1, the database 103 is located on the server 102. However, the database 103 could be remotely located, that is, the database 103 is not located on the server 102. Additionally, the database 103 may be located on one or more servers 102. FIG. 4 contains more details about the server 102 and database 103.

In FIG. 1, customers 104, 105, 106, 108, 110, 112, 114, and 116 provide customer feedback to the organization 101. The customers may engage with the organization 101 by receiving and/or consuming a product and/or service provided by the organization 101. Alternatively, the customers may be former recipients and/or consumers of the products and/or services provided by the organization 101. Furthermore, the customers may be potential future recipients and/or consumers of the products and/or services provided by the organization 101. Also, the customers may be consumers or recipients of marketing materials from the organization 101.

Customers 104, 105, 106, 108, 110, 112, 114, and 116 may currently have or used to have an insurance policy with the organization 101. In some embodiments, the customers are shopping for an insurance policy and may be considering policies from organization 101. The customers may have viewed an advertisement about the products and/or services from organization 101. In some cases, the viewed advertisement is for an insurance policy from organization 101.

Customers 104, 105, 106, 108, 110, 112, 114, and 116 may be one or more persons, a legal entity, business, and/or organization. In some instances, the customers are an employee or agent of a legal entity, business, and/or organization. In FIG. 1, customers 104, 105, 106, 108, 110, 112, 114, and 116 are external to the organization 101. However, in some embodiments, the customers 104, 105, 106, 108, 110, 112, 114, and 116 may be internal customers of the organization 101.

In the displayed embodiment of FIG. 1, customers 104, 105, 106, 108, 110, 112, 114, and 116 provide three types of feedback to the organization 101. The types of feedback are survey feedback 140, direct feedback 142, and social media feedback 144. In some embodiments of the organization feedback environment 100, not all of the types of feedback displayed are used, while in other embodiments, additional types of feedback are used.

FIG. 1 shows that survey feedback 140 is provided by customer 104 and customer 105 to organization 101. Specifically, customer 104 provides feedback to organization 101 via survey 122. Also, customer 105 provides feedback to organization 101 via survey 123. In some instances, survey 122 and survey 123 are the same survey, while in other instances, surveys 122 and 123 are different surveys. Customers 104 and 105 may complete more than one survey for organization 101. In some cases, customers 104 and 105 complete the surveys 122 and 123 after receiving them from organization 101. The surveys 122 and 123 may be sent and received by the organization 101 via different channels, such as email, telephone, mail, fax, text message, hand-delivered, or by some other method. Surveys 122 and 123 may be written surveys or orally communicated surveys. In some cases, surveys 122 and 123 are transmitted and/or received by the organization 101 at the same time, while in other cases, surveys 122 and 123 are transmitted and/or received by the organization 101 at different times.

As shown in FIG. 1, customers 106, 108, 110, and 112 provide direct feedback 142 to organization 101. Direct feedback 142 may be communicated between a customer, or some other party, to organization 101 via different channels, such as email, telephone, mail, fax, text message, hand-delivered, meeting, online, website, chat, or by some other method. For example, FIG. 1 shows customer 106 providing direct feedback to organization 101 via an online channel 124. In some embodiments, online channel 124 includes an online chat between the customer 106 and a representative for organization 101.

In FIG. 1, customer 108 provides direct feedback to organization 101 via a phone call 126. Phone call 126 may be initiated by either the organization 101 or the customer 108.

As depicted in FIG. 1, customer 110 provides direct feedback to organization 101 via a website 128. The website 128 may or may not be the website of the organization 101. Customer 110 may provide feedback via a website 128 by entering text into a text entry box on the website 128.

FIG. 1 shows that customer 112 provides direct feedback to organization 101 via an email 130. Customer 112 may initiate the email 130 that is sent to the organization 101, or send the email 130 in response to an email received from the organization 101. Also, other channels not displayed may be used by customers to transmit direct feedback, such as text messages, fax, face-to-face conversations, videoconferencing, telepresence, or other methods of transmission. In some instances, customers 106, 108, 110, 112 use one or more channels (such as online 124, phone call 126, website 128, email 130, etc.) to provide direct feedback to organization 101. The direct feedback may be a customer complaint. Customers 106, 108, 110, 112 may transmit more than one customer complaint via a channel. In some embodiments, the organization 101 does not receive direct feedback 142 via all of the channels displayed.

FIG. 1 also shows that customers 114 and 116 provide social media feedback 144 about the organization 101. In FIG. 1, customer 114 provides social media feedback 144 via a preference button 132 on social media website 118. In some cases, customer 114 actively indicates a preference to social media website 118, such as by clicking on a preference button. Also, social media website 118 may determine setting a preference for customer 114 based on data about customer 114. The data can include the customer's activity, profile, traits, age, gender, interests, hobbies, and/or other data about the customer. Alternatively, social media website 118 may determine a preference from customer 114 via polling.

In FIG. 1, customer 116 provides social media feedback 144 via a message 134 on social media website 120. In some embodiments, message 134 is a blog, microblog with a character limit, status message, picture, republication, forwarded message, reference to a message or topic, and/or other communication provided by customer 116 to social media website 120.

Organization 101 receives social media feedback 144 by monitoring (136, 138) social media websites 118 and 120. Monitors 136 and 138 could include messages transmitted between organization 101 and social media websites 118 120.

Alternatively, organization 101 may have one or more accounts with social media websites 118 and 120. The accounts may populate any feedback received by social media websites 118 and 120 regarding the organization 101. Organization 101 would then monitor (136, 138) the social media feedback 144 by accessing the accounts to view the feedback about the organization 101 received by social media websites 118 and 120. In some embodiments, not all of the displayed social media feedback 144 is utilized by the organization 101. In some embodiments, other types of social media feedback 144 that are not displayed are monitored by organization 101.

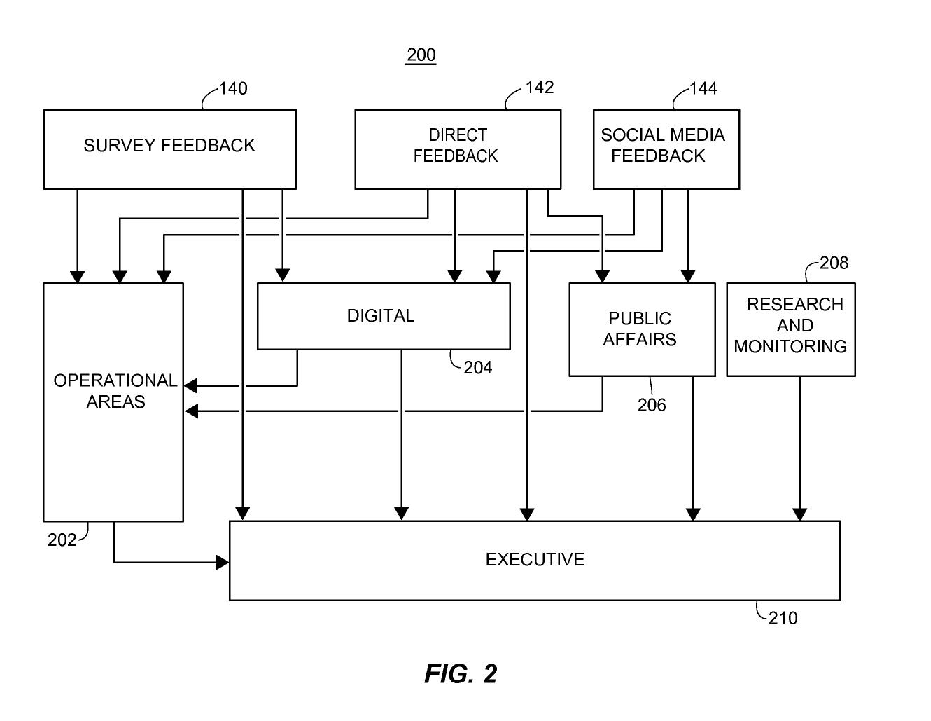

FIG. 2 is a diagram of the feedback transmission sequence 200 within an organization 101 that doesn't use the customer feedback system, according to one embodiment. The feedback transmission sequence 200 shows how an organization 101 may gather feedback to forward to different parts of the organization to improve the organization as a whole. However, a few problems may occur for an organization 101 during the sequence 200. First, some feedback may be unnecessarily forwarded to various departments of an organization 101. This is inefficient. Second, some departments may not receive the full benefits of all of the feedback gathered. The customer feedback system can address both of these issues.

In the displayed embodiment of the feedback transmission sequence 200 for an organization 101 that doesn't use a customer feedback system, the organization 101 may collect three types of feedback. These types include survey feedback 140, direct feedback 142, and social media feedback 144. The organization 101 may have various departments relying on the gathered feedback to improve the organization 101. In the displayed embodiment, these departments include operational areas 202, digital 204, public affairs 206, research and monitoring 208, and executive 210.

In the displayed embodiment, the full benefits of the gathered feedback are not received by every department of the organization. For example, survey feedback 140 is not forwarded to public affairs 206 or research and monitoring 208. Additionally, direct feedback 142 is not forwarded to research and monitoring 208. Furthermore, social media feedback is not utilized by research and monitoring 208 or executive 210. As a result, public affairs 206, research and monitoring 208, and executive 210 may not be receiving the full benefits of the collected survey feedback 140, direct feedback 142, and social media feedback 144. Also, it is possible that the feedback that is being forwarded to various departments is repetitive and/or unnecessary.

In some embodiments, different types of feedback are gathered than those of the displayed embodiment. In some embodiments, fewer or more types of feedback are gathered then those displayed. In some embodiments, the feedback gathered is transmitted to different departments than those displayed. In some embodiments, the gathered feedback may be transmitted to fewer or more departments than those displayed.

The customer feedback system can address both of the issues with the displayed embodiment of FIG. 2. First, the customer feedback system can integrate and filter the gathered data for efficient use by the departments of an organization. Second, the customer feedback system can factor in the needs of the departments of the organization 101 when determining whether to retain, discard, or deemphasize feedback. As a result, the full benefits of the gathered feedback are transmitted efficiently to the departments of an organization 101 by the customer feedback system.

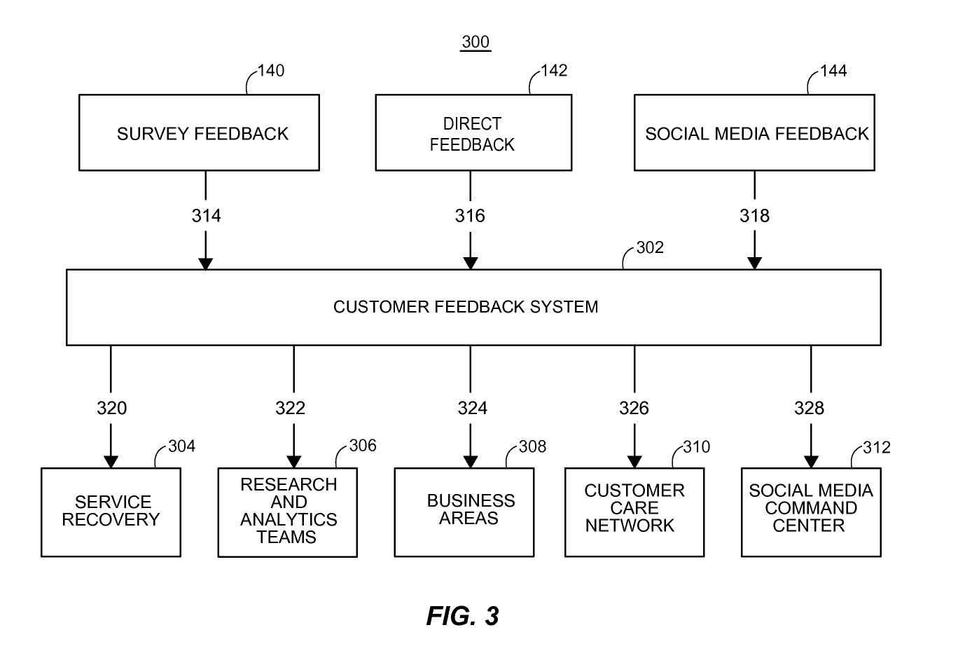

FIG. 3 is a diagram of the feedback transmission sequence 300 within an organization that does use the customer feedback system, according to one embodiment. In the displayed embodiment, feedback transmission sequence 300 includes gathering survey feedback 140, direct feedback 142, and social media feedback 144. The feedback is transmitted (314, 316, and 318) to customer feedback system 302. The customer feedback system 302 then receives, stores, processes, updates, modifies, filters, and/or integrates the transmitted feedback, as is required by the different departments of the organization 101. The customer feedback system 302 then transmits (320, 322, 324, 326, and 328) the requested outputs to various departments in the organization. These departments include service recovery 304, research and analytics teams 306, business areas 308, customer care network 310, and social media command center 312.

As a result, the customer feedback system 302 addresses the issues of the feedback transmission sequence 200 for an organization 101 that lacks the customer feedback system 302. First, the customer feedback system 302 can filter unnecessary feedback from being transmitted to various departments within an organization 101. Second, customer feedback system 302 provides the full benefits of the gathered feedback to the various departments of the organization by integrating and filtering the gathered feedback. In some embodiments, the customer feedback system 302 may help an organization 101 coordinate responses, monitor issues and impact, identify additional research needs, improve planning and prioritization, and report data.

In some embodiments, different types of feedback may be gathered from the customer feedback system than what is displayed. In some embodiments, fewer or more types of feedback may be gathered by customer feedback system than what is displayed. In some embodiments, the customer feedback system may send outputs to different departments than those shown in the displayed embodiment. In some embodiments, the customer feedback system may send outputs to fewer or more departments than those shown in the displayed embodiment.

### Customer Feedback System Implementation

FIG. 4 is a block diagram of a customer feedback system implementation 400, according to one embodiment. The system 400 may be implemented by server 102 in communication over network 416 with other devices. Server 102 may communicate over network 416 with customer computing device 420. Additionally, the server 102 may be accessed over the network 416 by user-interface 412B and organization computing device 418. In some embodiments, fewer or more devices communicate with server 102 over network 416. In some embodiments, different devices communicate with server 102 over network 416.

As mentioned earlier in FIG. 1, server 102 may be, for example, a computer, a server, a plurality of networked computing devices having a logical appearance of a single computing device, a plurality of cloud computing devices, etc. Accordingly, for ease of discussion only and not for limitation purposes, the server 102 is referred to herein using the singular tense, although in some embodiments the server 102 may include more than one physical computing device.

The server 102 may include a memory 407, a processor 401 (may be called a controller, a microcontroller, or a microprocessor), a random-access memory (RAM) 40., and an input/output (I/O) circuit 415, all of which may be interconnected via an address/data bus 405. The memory 407 may comprise one or more tangible, non-transitory computer-readable storage media or devices, and may be configured to store computer-readable instructions that, when executed by the processor 401, cause the server 102 to implement the customer feedback system 302.

Memory 407 may store computer-readable instructions and organize them into modules that can be executed to implement the customer feedback system 302. In the displayed embodiment, memory 407 stores feedback storing module 402, feedback processing module 404, feedback relation module 406, text mining module 408, feedback analysis module 409, and output initiation module 410. In some embodiments, the memory 407 may store different modules than those displayed, while in other embodiments, the memory 407 may store fewer or more modules than those displayed. In some embodiments, the executable computer-readable instructions may not be organized as modules. In some embodiments, instructions may be organized as routines, subroutines, or other blocks of instructions.

Memory 407 includes feedback storing module 402. Feedback storing module 402 includes instructions executed by processor 401 to handle feedback items received at either the network interface 414 or user interface 412A. The feedback storing module 402 stores the items in database 103. After the server 102 receives the feedback items, and before feedback storing module 402 stores the items in database 103, feedback storing module 402 may call feedback processing module 404 and feedback analysis module 409 to process and analyze the received feedback items.

Feedback processing module 404 may be called by feedback storing module 402 to process received feedback items for storage at database 103. Processing may include organizing, formatting, filtering, and performing other actions on the received feedback items for storage at database 103.

Feedback processing module 404 may also be called after feedback storing module 402 is complete. That is, feedback processing module 404 may be executed after the received feedback items are stored at database 103. In this case, feedback processing module 404 may organize, format, filter, and perform other actions on the stored feedback items to enhance storage at database 103.

Feedback analysis module 409 may be called by feedback storing module 402 after feedback items are received by server 102 before storage at database 103. In this case, the feedback analysis module 409 may analyze the text, speech, images, and/or other feedback items received by server 102. For example, feedback analysis module 409 may be called by feedback storing module 402 to conduct the voice analysis of a phone call customer feedback item received by server 102. This voice analysis may indicate the level of stress of the caller, thereby providing better insight on customer sentiment regarding a product or service.

Feedback relation module 406 determines whether multiple feedback items stored in database 103 are related. Feedback relation module 406 may determine that multiple feedback items are related because they all exhibit a common trait. A common trait could include feedback about the same product, service, marketing materials, and/or feedback from the same customer or group of customers.

In some embodiments, the common trait may be a type of insurance policy, such as a car insurance policy. In some embodiments, the common trait may be about an event, such as a weather related event. For example, the common trait may be that the feedback items are about insurance coverage for an earthquake, hurricane, tornado, typhoon, tidal wave, blizzard, storm, hailstorm, monsoon, flood, or fire.

In some embodiments, the common trait may be that all the feedback is from the same customer. The same customer may have submitted multiple feedback items about the same topic. For example, the customer may have emailed a complaint about his auto insurance policy and also called to complain about the same auto insurance policy.

Alternatively, the same customer may submit multiple feedback items about different topics. For example, the customer may have called to complain about his auto insurance policy and then submitted a survey complaining about the responsiveness of the insurance organization's agent during the phone call. In either scenario, the multiple feedback items will be linked together as related by the feedback relation module 406. This is useful for the organization 101 to analyze a specific customer's sentiment about the organization 101, and whether the organization 101 is in danger of losing the customer.

The feedback relation module 406 may call text mining module 408 to help determine whether feedback items stored at database 103 are related. Alternatively, agents of the organization 101 may determine whether a received feedback item is related to any stored feedback items at database 103. The agent may identify related items and update the database 103 to reflect this. Feedback relation module 406 would then retrieve and output these related items. The feedback relation module 406 may output related feedback items to feedback analysis module 409 and output initiation module 410.

Alternatively, the agent of the organization 101 may determine related feedback items within the database 103 and output them to other modules. In this case, the feedback relation module 16 may not be needed.

Text mining module 408 may be called by feedback relation module 406 to mine text of multiple feedback items to determine if they contain common traits. Text mining module 408 may search database 103 for feedback items that contain identical text and return these feedback items to feedback relation module 406. Feedback relation module 406 may then determine whether these feedback items are actually related or merely coincidentally have identical text.

For example, feedback relation module 406 may receive from text mining module 408 feedback items from a customer named John Doe and another customer named Jane Doe because of the identical text “Doe” in the customer name. Feedback relation module 406 may then determine whether or not the items are related. For example, in one embodiment, the items may not be related because Jane Doe and John Doe are different people with no other relation. But in a different embodiment, feedback relation module 406 may deem the items related because Jane Doe and John Doe are married to each other, meaning the feedback items are related because they are from the same family.

Output initiation module 410 may generate outputs for the customer feedback system 302 based on the feedback items stored at database 103. Output initiation module 410 may rely on the results of feedback relation module 406 and feedback analysis module 409 to determine what outputs to initiate. Output initiation module 410 may retrieve the results of feedback relation module 406 to determine which feedback items in database 103 are related.

Output initiation module 410 may then call feedback analysis module 409 to determine customer sentiment based on the related feedback items from feedback relation module 406. Outputs initiation module 410 may have a predetermined threshold at which an output is initiated. Outputs initiation module 410 may then retrieve the results of feedback analysis module 409 to determine customer sentiment from the related feedback items. Output initiation module 410 may then compare the customer sentiment results from feedback analysis module 409 to the predetermined threshold to determine if an output should be initiated. In some embodiments, if the customer sentiment is higher than the threshold, then an output is initiated. In other embodiments, if the customer sentiment is lower than the threshold, then an output is not initiated.

Output initiation module 410 initiates a variety of outputs. These outputs include trending, reporting, modifying, and/or updating the data for the organization. Additionally, outputs may include alerting and/or alarming the organization based on the threshold comparison. Other outputs may be possible by the output initiation module 410.

The feedback analysis module 409 may be called by the output initiation module 410 to analyze related feedback items outputted from feedback relation module 406. The feedback analysis module 409, in this case, determines customer sentiment based on the related feedback items. In one embodiment, the feedback analysis module 409 determines customer sentiment by summing the related feedback items outputted by feedback relation module 406. In some embodiments, the feedback analysis module outputs this sum to the output initiation module 410.

The feedback analysis module 409 may also do a weighted analysis of the feedback items to determine customer sentiment. In some embodiments, the feedback analysis module 409 assigns weights to each related feedback item. In some embodiments, the feedback analysis module 409 calculates customer sentiment by taking the sum of the weighted feedback items. In some embodiments, this calculated customer sentiment based on weighted feedback items is then outputted to the output initiation module 410 for comparison against a predetermined threshold. In some embodiments, the feedback analysis module 409 may determine customer sentiment via other methods. In some embodiments, the feedback analysis module 409 may perform other analysis for the customer feedback system modules.

The server 102 may be operatively connected to receive feedback items over the network 416 via I/O circuit 415 and network interface 414. The server 102 may connect to the network 416 at the network interface 414 via a wired or wireless connection, or other suitable communications technology. The network 416 may be one or more private or public networks. The network 416 may be a proprietary network, a secure public internet, a virtual private network or some other type of network, such as dedicated access lines, plain ordinary telephone lines, satellite links, combinations of these, etc. Where the network 416 comprises the Internet, data communications may take place over the network 416 via an Internet communication protocol, for example.

The server 102 may receive feedback items from a customer computing device 420 via the network 416. The server 102 may receive customer feedback items from one or more customer computing devices 420. The customer computing device 420 may be a computer, laptop, mobile phone, PDA, tablet, or other computing device that can access the network 416. Alternatively, the customer computing device 420 may provide feedback items to organization computing device 418 over the network 416.

The server 102 may receive feedback items from an organization computing device 418. The server 102 may receive customer feedback items from one or more organization computing devices 418. Organization computing device 418 may be a computer, laptop, mobile phone, PDA, tablet, or other computing device that can access network 416. In some embodiments, the organization computing device 418 is a computing device that belongs to the organization 101 or an agent of the organization 101.

In some embodiments, an agent of the organization 101 may receive feedback items directly from a customer via a phone call, face-to-face meeting, or other method. The agent of the organization 101 may then transmit the feedback items to the server 102 over the network 416 via their organization computing device 418. Organization computing device 418 may also permit an agent of the organization 101 to access, modify, update, report, and/or perform some other action on data stored at the database 103 in server 102. Alternatively, an agent of the organization 101 may send, access, modify, update, and/or send data at the server 102 via the user interfaces 412A or 412B.

The user interfaces 412A and 412B may be used by a customer or an agent of the organization 101 to provide feedback items to the server 102. The user interface 412A may be integral to the server 102. Alternatively, the user interface may not be integral to the server 102, such as user interface 412B. For example, user interface 412B may be a remote user-interface at a remote computing device, such as a webpage or client application.

The database 103 may be configured or adapted to store data related to customer feedback system 302. The database 103 may be used to store various feedback items, including survey feedback 140, direct feedback 142, and social media feedback 144. The database 103 may store other data relevant to the customer feedback system 302. As mentioned earlier in FIG. 1, the database 103 may be located at server 102. Alternatively, the database 103 may be located remotely from server 102. Furthermore, parts of the database 103 may be located at the server 102 while other parts of the database 103 may be located remotely from server 102.

Although only one processor 401 is shown, the server 102 may include multiple processors 401. Additionally, although the I/O circuit 415 is shown as a single block, it should be appreciated that the I/O circuit 415 may include a number of different types of I/O circuits. Similarly, the memory of the server 102 may include multiple RAMs 403 and multiple program memories 407. Further, while the instructions and modules are discussed as being stored in memory 407, the instructions and modules may additionally or alternatively be stored in the RAM 403 or other local memory (not shown).

The RAM(s) 403 and program memories 407 may be implemented as semiconductor memories, magnetically readable memories, chemically or biologically readable memories, and/or optically readable memories, or may utilize any suitable memory technology.

### Survey Feedback

Customer feedback system 302 relies on three types of feedback items. These items include survey feedback 140, direct feedback 142, and social media feedback 144. Surveys allow organization 101 to solicit structured feedback from customers about topics in which organization 101 is interested. One benefit of structured feedback is that the data is projectable. Thus, surveys may allow organization 101 to receive structured feedback about topics organization 101 is interested in, and thereby make business projections on this data. In one embodiment, projections on structured data regarding insurance policies may include acquisition rates, household retention, and information about policies lapsing or being canceled.

When designing customer surveys, an organization 101 may consider several factors, including using consistent questions and scales to measure feedback data, coordinating surveys administered across multiple channels, determining which customers to sample and how frequently to administer surveys. Organization 101 may gather survey feedback about topics that vary in scope.

For broader topics, organization 101 may design surveys to measure customer sentiment about the organization 101, the organization's brand, or the multichannel experience of the customer with the organization. This type of feedback allows the organization to measure the overall customer experience when engaging with organization 101.

Narrower survey topics may allow an organization 101 to measure customer satisfaction with specific channels, products, or representatives. For example, a survey could be designed to determine customer sentiment about contacting the organization via specific channels, such as phone calls, online, online chats, in person meetings, email, and/or other channels. Additionally, customer sentiment about specific products, such as auto insurance policies, fire insurance policies, life insurance policies, etc. could also be measured with surveys. An even narrower survey topic, such as customer sentiment regarding a specific interaction or specific part of a channel, could be used to measure customer satisfaction in certain situations.

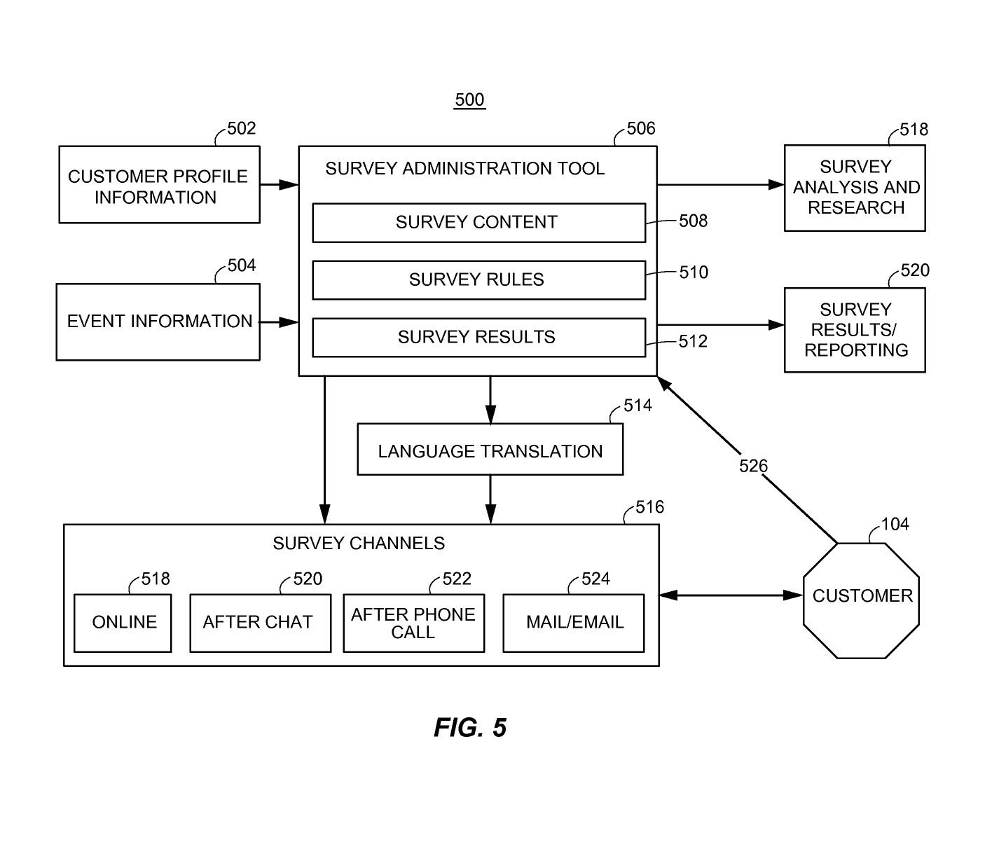

FIG. 5 is a diagram of survey feedback procurement 500 for an organization 101, according to one embodiment. In the displayed embodiment, survey feedback procurement 500 may include a survey administration tool 506. The survey administration tool 506 generates and sends surveys to one or more customers 104. The survey administration tool 506 also gathers surveys from one or more customers 104.

The survey administration tool 506 may rely on customer profile information 502 and event information 504 to generate surveys. The survey administration tool 506 may modify survey content 508 according to survey rules 510 to generate a survey. The survey administration tool 506 may examine survey results 512 of previous surveys to improve generated surveys.

The survey administration tool 506 employs multiple survey channels 516 to send surveys to one or more customers 104. If necessary, the survey administration tool 506 can forward surveys to language translation 514 before transmitting the survey across a survey channel 516 to better accommodate one or more customers 104 who speak different languages.

Surveys can be administered via one of several survey channels 516. These channels include online 518, after chat 520, after phone call 522, or mail or email 524. In some embodiments, different survey channels exist. In some embodiments, fewer or more survey channels can be used to transmit surveys to one or more customers 104.

After the customer 104 completes the received survey, customer 104 can then transmit (block 526) the survey back to the survey administration tool 506. Upon receiving the survey, the survey administration tool 506 may update survey results 512. In some embodiments, an organization 101 with a customer feedback system 302 may store received (block 526) surveys from one or more customers 104. The received surveys are stored in database 103 of server 102 for the customer feedback system 302. The generated surveys and survey results 512 may be useful for survey analysis and research 518 and survey results and reporting 520.

In some embodiments, survey administration tool 506 may use different, fewer, and/or more steps to administer surveys. In some embodiments, survey administration tool 506 may use different, less, and/or more information to generate surveys. In some embodiments, survey administration tool 506 may have different, fewer, and/or more uses for the generated surveys and survey results.

### Direct Feedback

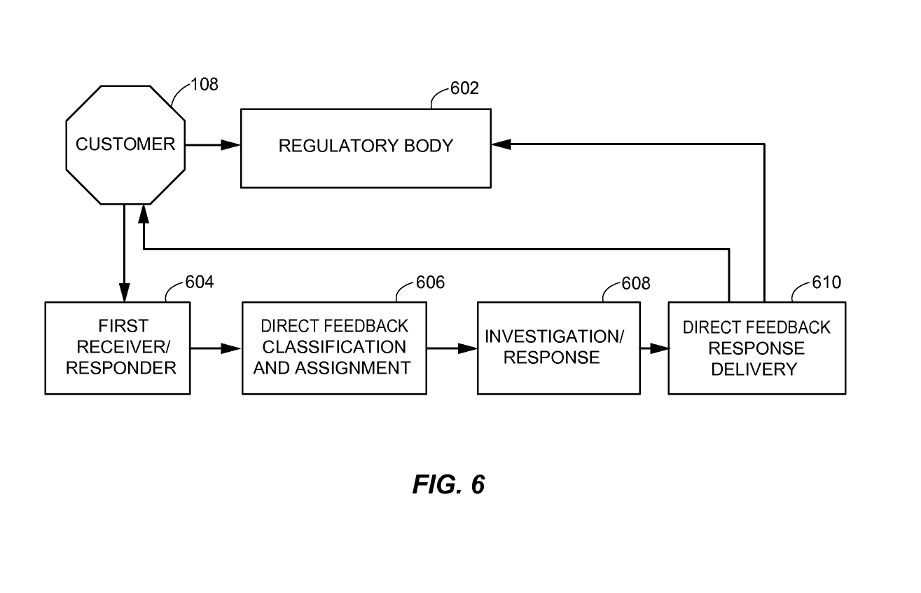

FIG. 6 is a diagram of direct feedback procurement 600 for an organization 101, according to one embodiment. Direct feedback tends to be unsolicited, unstructured feedback. Direct feedback can allow an organization 101 to gather deep insights into customer sentiment. Deep insights from unstructured feedback can be determined by using analytical tools on unstructured feedback in different forms, such as speech, text, or online feedback. For example, a voice analysis of a phone call customer complaint (a type of direct feedback) about an insurance policy can be done to detect stress levels. This analysis helps the organization 101 garner deep insights about customer sentiment regarding the insurance policy.

Direct feedback procurement 600 begins with customer 108 providing direct feedback to organization 101. The agent of the organization 101 that receives the direct feedback from the customer 108 is deemed the first receiver or first responder 604. The first responder 604 may attempt to resolve the issue of customer 108. The first responder 604 may also identify the feedback as negative. For an organization 101 using a customer feedback system 302, the first responder 604 may then update the database 103 of the customer feedback system 302 to include the direct feedback.

Next, classification and assignment of the stored direct feedback 606 occurs. The stored direct feedback may be classified based on the type of direct feedback, the channel by which it was received, the topic of the direct feedback, the level of negativity of the direct feedback, and/or other criteria. The classified direct feedback is assigned to an agent within the organization 101 to be the accountable party for resolving the direct feedback. The database 103 of the customer feedback system 302 may be updated to reflect the classification and accountable party for the stored direct feedback.

Next, the accountable party conducts an investigation and generates a response for the direct feedback (block 608). As part of the investigation and response generation, the accountable party may collaborate with relevant parties and analyze the issue to resolve the direct feedback. The database 103 of the customer feedback system 302 may be updated to reflect the investigation and generated response for the stored direct feedback.

Once the response is generated, a delivery method for the response is selected and the response is delivered (block 610). The response may be delivered to the customer 108, along with a regulatory body 602, if necessary. In one embodiment, customer 108 makes a complaint to an insurance company 101. The complaint is such that the response is required to be delivered (block 610) to both customer 108 and a regulatory body 602. In some embodiments, the regulatory body 602 may be the National Association of Insurance Commissioners (NAIC). The response may be delivered to other and/or multiple regulatory bodies 602, if necessary. The response may also be delivered to multiple customers 108, if necessary. Database 103 of the customer feedback system 302 may be updated to reflect the delivery method, delivered response, and recipients of the delivered response for the stored direct feedback.

Customer feedback system 302 provides several advantages for stored and updated direct feedback data located in database 103. First, the stored and updated direct feedback data can be compared against traditional data and/or older data stored in the customer feedback system 302. Second, the stored and updated direct feedback data can be used for research and analysis by research and analytical teams internal or external to the organization 101. This data may be useful for statistical analysis and may provide a richer database of information for future analysis. Also, this data can help an organization 101 determine the root causes for the direct feedback, potential improvements, and actions the organization 101 can take to reduce complaints.

In some embodiments, the direct feedback procurement 600 may use different, fewer, and/or more steps to respond to direct feedback than those shown in the displayed embodiment.

### Social Media Feedback

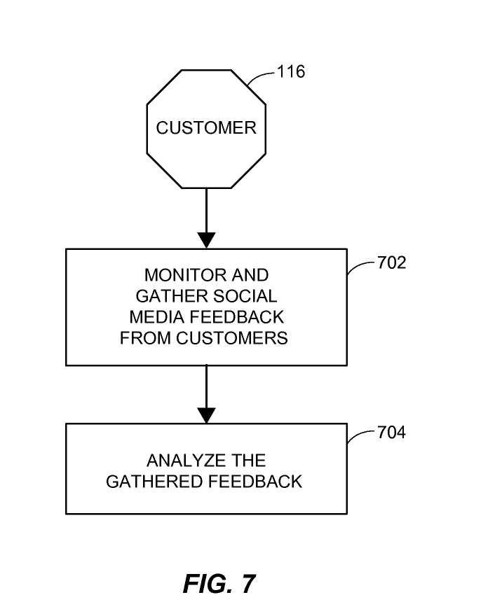

FIG. 7 is a diagram of social media feedback procurement 700 for an organization, according to one embodiment. Similar to direct feedback, social media feedback tends to be unsolicited, unstructured feedback. Social media feedback also provides deep insights into customer sentiment. As was mentioned earlier for direct feedback, analytical tools can also be used on social media feedback to gather deep insights into customer sentiment.

As was discussed earlier in FIG. 1, a customer 116 may generate social media feedback by providing communications to social media websites. Social media feedback could include a blog, microblog with a character limit, status message, picture, republication, forwarded message, reference to a message or topic, preference, and/or other communications provided by customer 116 to the social media website.

The organization 101 may monitor and gather social media feedback provided by the customer 116. As mentioned earlier in FIG. 1, the organization 101 may monitor the feedback by directly messaging the social media websites about customer provided social media feedback. Alternatively, the organization 101 may have accounts with social media websites that are populated by social media feedback from customers 116 about the organization 101. An organization 101 may access these accounts to then monitor the social media feedback generated by the customers 116 about the organization 101. In some embodiments, other methods may be used by an organization 101 to monitor social media feedback by customers 116 about the organization 101.

The organization 101 may then analyze the gathered social media feedback to gain further insight about customer sentiment, the needs of the customer 116 and organization 101, the preferences of customer 116, and other relevant information. The social media feedback may be stored at database 103 of the customer feedback system 302 to enhance the above analysis. Integration of the social media feedback with other types of feedback may improve the organization's 101 research and assessment of customer experience.

### Customer Feedback System Output Transmission and Generation

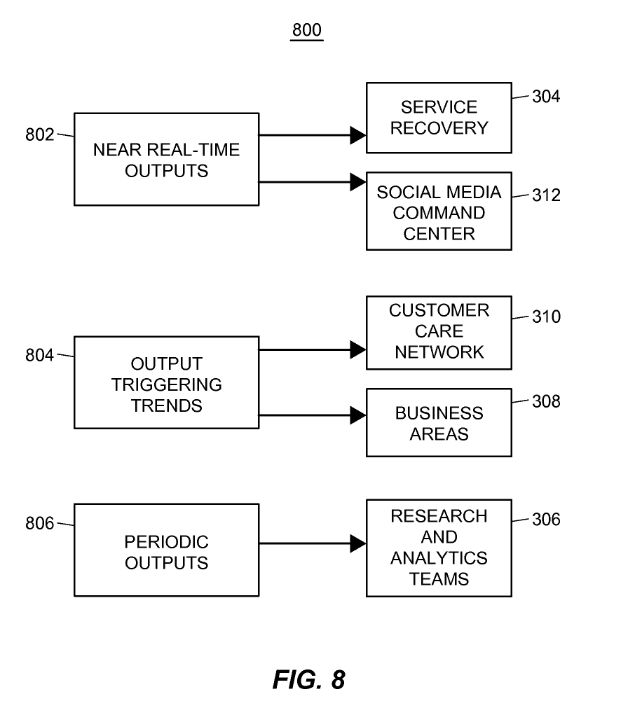

FIG. 8 is a diagram of customer feedback system output transmission 800 for an organization 101, according to one embodiment. The customer feedback system 302 can initiate an action to generate an output based on the analysis of analyzing the related, integrated, stored feedback items in database 103. The various types of outputs generated will depend on the needs of the organization 101 and its components.

In the displayed embodiment of FIG. 8, customer feedback system output transmission 800 includes three types of outputs that are initiated by the customer feedback system 800. These outputs are near real-time outputs 802, output triggering trends 804, and periodic outputs 806. Different components of an organization 101 can receive the outputs. In the displayed embodiment, the components of the organization 101 that receive the outputs are service recovery 304, social media command center 312, customer care network 310, business areas 308, and research and analytics teams 306.

Near real-time outputs 802 are data that are real-time or near real-time. Near real-time outputs 802 may be useful for an organization when quick actions or responses are required. Given this, the near real-time outputs 802 are forwarded to service recovery 304 and social media command center 312. In one embodiment, service recovery 304 uses the near real-time outputs 802 to determine if the customer may be at risk of leaving the organization 101 due to poor service. If so, service recovery 304 may choose to contact that customer to retain their business. In one embodiment, social media command center 312 may use near real-time outputs 802 to quickly respond to negative social media feedback.

Output triggering trends 804 are feedback items that are tracked, monitored, trended and initiate outputs due to the results of the trended feedback items. Output triggering trends 804 are useful for identifying system issues and process breakdowns by an organization regarding the delivery of their products and services. Output triggering trends 804 may also be used to identify items requiring training or coaching to possibly address the identified system issues and process breakdowns. As a result, output triggering trends 804 may be used by customer care network 310 and business areas 308 to identify items requiring training and coaching to address the system issues and process breakdowns that caused the output triggering trends 804.

Periodic outputs 806 are outputs that are repeatedly sent from the customer feedback system 302 to different parts of an organization 101. In some cases, periodic outputs 806 transmissions occur after a fixed amount of time. In some cases, periodic outputs 806 are retransmitted when the outputs adjust due to changes in the stored feedback items in database 103. These outputs may be useful for periodically reporting data and providing updated data.

Given this, in the displayed embodiment, periodic outputs 806 are sent to research and analytics teams 306 within the organization 101. For example, the organization 101 may use periodic outputs 806 to generate monthly reports about how a product or service is doing. The data could be used to help populate a dashboard product for the organization 101 that indicates how the product or service is doing.

In another example, voice stress levels that have been determined by analyzing customer complaint phone calls may be sent to research teams within an organization to provide them updated data. By doing so, the research teams may be able to make more accurate determinations.

In some embodiments, components of an organization 101 may use multiple outputs from the customer feedback system output transmission 800. For example, a dashboard product for the organization 101 that indicates how certain products or services are performing may use near real-time outputs 802, output triggering trends 804, and periodic outputs 806. As was mentioned earlier, periodic outputs 806 may be used to indicate performance. Near real-time outputs 802 may be used for critical data that requires up to date information. Output triggering trends 804 may be used to signal possible system issues or process breakdowns that may explain the performance of certain products or services. Each type of output may help a dashboard product for the organization 101 provide better data to assess performance of a product and/or service by the organization 101.

In some embodiments, the customer feedback system output transmission 800 includes fewer, more, and/or different outputs than those displayed. In some embodiments, the customer feedback system output transmission 800 may send outputs to fewer, more, and/or different parts of an organization than those displayed. In some embodiments, the various uses of the outputs of the customer feedback system output transmission 800 may be fewer, more, and/or different than the uses displayed and/or discussed earlier.

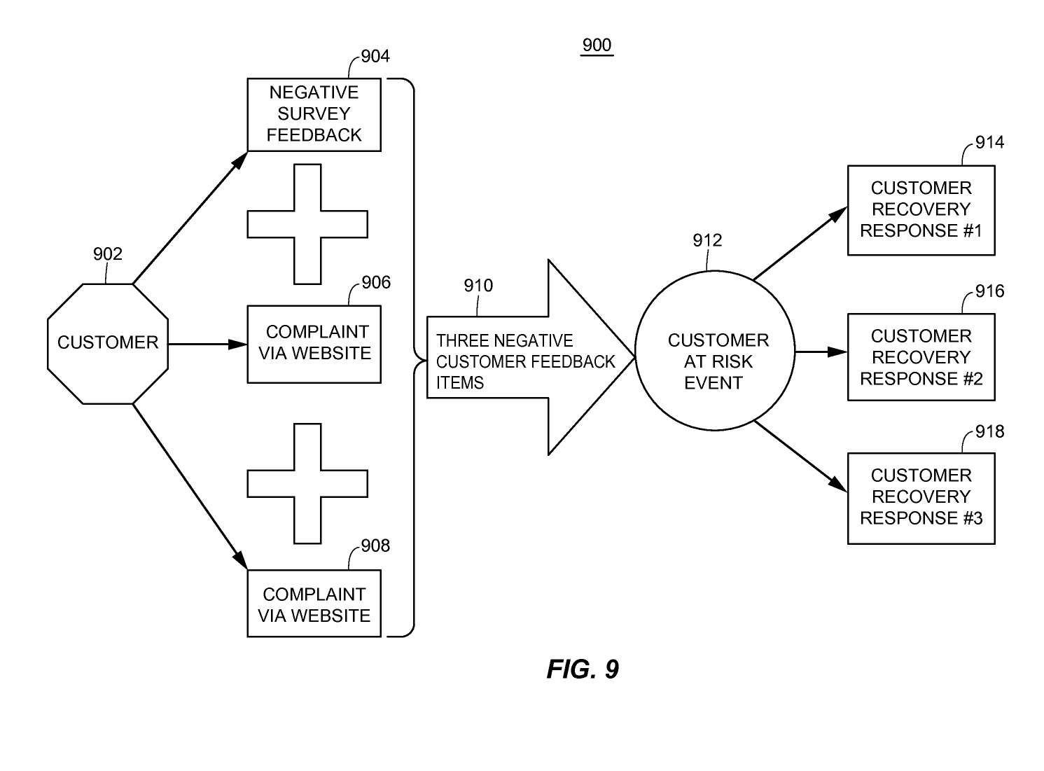

FIG. 9 is a diagram of customer feedback system output generation 900 for an organization 101, according to one embodiment. The customer feedback system output generation 900 relies on analysis of stored, integrated, related feedback items at database 103. Feedback items are related when they exhibit a common trait. As was discussed earlier in FIG. 4, a common trait of the feedback items could be that the items are from the same customer or group of customers. For example, if a group of feedback items were all from John Doe, these items would be related.

Alternatively, the common trait of the feedback items could be that they are about the same topic. For example, if the group of feedback items were all about an auto insurance policy, these feedback items may be related. Another example would be if the group of feedback items were all about the same customer service representative, then these items would be related.

Another alternative may be that the common trait of the feedback items is a same event. For example, a group of feedback items may be about the insurance policies and services provided in connection to a specific weather related event, such as an earthquake, hurricane, tornado, typhoon, tidal wave, blizzard, storm, hailstorm, monsoon, flood, or fire. Because all of the feedback items were in regards to the same weather event, such as a recent earthquake, these items would be related.

In one embodiment, the generation of an output occurs when a group of related feedback items exceeds a threshold. The group of related feedback items may be summed together. The sum may then be compared against the threshold. If the sum is greater than or equal to the threshold, the customer feedback system 302 initiates an action to generate an output.

In some embodiments, the threshold may be predetermined. For example, a threshold of three negative feedback items from one customer may be predetermined to require a customer recovery response. In some embodiments, the threshold can be dynamically adjusted based on rules for the customer feedback system 302.

For example, a threshold may adjust from three negative feedback items to five negative feedback items based on the current date and time. Specifically, during normal business hours (Monday through Friday, 9 AM-5 PM), the threshold may be three negative feedback items. However, at all other times, the threshold may be five negative feedback items. This may be done to prevent the customer recovery response, such as calling and/or contacting the customer, from occurring during inconvenient hours for the customer and/or organization 101.

Different thresholds can be used for different types of related feedback items. For example, negative feedback items relating to a common customer may have a threshold of three. However, negative feedback items relating to a product, such as an auto insurance policy, may have a threshold of nine.

In some embodiments, the feedback items may be weighted to determine a generation. Specifically, within a group of related feedback items, each feedback item may be assigned a weight. The weighted feedback items are then summed together. The sum is then compared against the threshold. If the sum is greater than or equal to the threshold, the customer feedback system 302 initiates an action to generate an output.

FIG. 9 shows an example of related feedback items having a common customer leading to the generation of an output. In FIG. 9, the threshold is set at three negative customer feedback items 910. The common trait of the negative feedback items, in this case, is that the same customer 902 has provided the negative feedback items. The group of negative feedback items includes negative survey feedback 904, a complaint via a website 906, and another complaint via a website 908 from the customer 902. The related negative feedback items are summed together for a total of three negative feedback items. The feedback items are then compared against the threshold 910 of three negative customer feedback items. Because this sum is greater than or equal to the threshold, the customer feedback system 302 initiates an action to generate an output.

In the displayed embodiment, the output generated is a customer at risk event 912. The output may then be forwarded to one or more components of an organization 101. As a result, the components of the organization may initiate their own actions based on the customer at risk event 912 output. In the displayed embodiment, one or more components of the organization 101 have responded to the customer at risk event 912 output with customer recovery response 914, customer recovery response 916, and customer recovery response 918.

For example, customer 902 may complete a negative survey 904 about his auto insurance policy. Customer 902 may also lodge a complaint via a website 906 about his auto insurance policy. Customer 902 may then lodge another complaint via a website 906 about a customer service representative.

The customer feedback system 302 may determine that the three negative feedback items 904, 906, and 908 meet the threshold of three negative customer events 910. As a result, the customer feedback system 302 initiates an action to generate a customer at risk event 912 output.

This output may then be forwarded to multiple components of the organization 101. For example, this output may be forwarded to service recovery 304, the customer care network 310, and business areas 308.

Upon receiving the customer at risk event 912 output, service recovery 304 may investigate feedback items 904, 906, and 908 and the common trait, customer 902, that caused the customer at risk event 912 output to be generated. Service recovery 304 may conclude after its investigation that the best course of action is to contact the customer 902 to try to retain his business. This determination may then lead to customer recovery response 914, which in this case is a phone call to the customer 902 to retain his business.

The customer care network 310 and business areas 308 also receive the customer at risk event 912 output. Customer care network 310 and business areas 308 may also investigate the feedback items 904, 906, and 908 and the common trait, customer 902, that caused the customer at risk event 912 output to be generated. The customer care network 310 and business areas 308 may identify specific system issues and process breakdowns that led to negative feedback items from the customer. The customer care network 310 may then initiate its own customer recovery response 916 based on its investigation. Business areas 208 may also initiate its own customer recovery response 918 based on the findings of its investigation.

For example, the customer care network 310 may determine that the root cause of the negative feedback items 904 and 906 from customer 902 about his auto insurance policy was a system issue or process breakdown, such as an issue with claim reimbursements. The customer care network 310 may determine that training and/or coaching may resolve the issue with claim reimbursements. This determination may then lead to customer recovery response 916, which in this case is the organization 101 conducting training and/or coaching to resolve the issue with claim reimbursements.

Also, business areas 308 may determine that the root cause of the negative feedback item 908 from customer 902 about a customer service representative was a system issue or process breakdown, such as an issue with training for the customer service representative. Business areas 308 may determine that additional training and/or coaching may resolve the training issue for the customer service representative. This determination may then lead to customer recovery response 918, which in this case is the organization 101 conducting training and/or coaching to resolve the training issue for the customer service representative.

The preceding example was in regards to related feedback items from one customer. However, in some embodiments, related feedback items from different customers about the same topic, such as a customer service representative, may also have a similar process for customer feedback system output generation.

In some embodiments, customer feedback system output generation 900 may have more, fewer, or different customer recovery responses that occur due to a customer at risk event 912 output being generated. In some embodiments, the customer at risk event 912 output is forwarded to fewer, more, and/or different components of an organization 101.

In some embodiments, different events or outputs could be generated by the customer feedback system than the displayed customer at risk event 912. In some embodiments, more events or outputs could be generated by the customer feedback system than the displayed customer at risk event 912.

In some embodiments, different common traits for related feedback items can be considered for whether or not to initiate an action to generate an output. These traits could include a same topic, same product, same service, same event, same weather related event, same group of customers, same customer, or other common trait.

### Customer Feedback Process

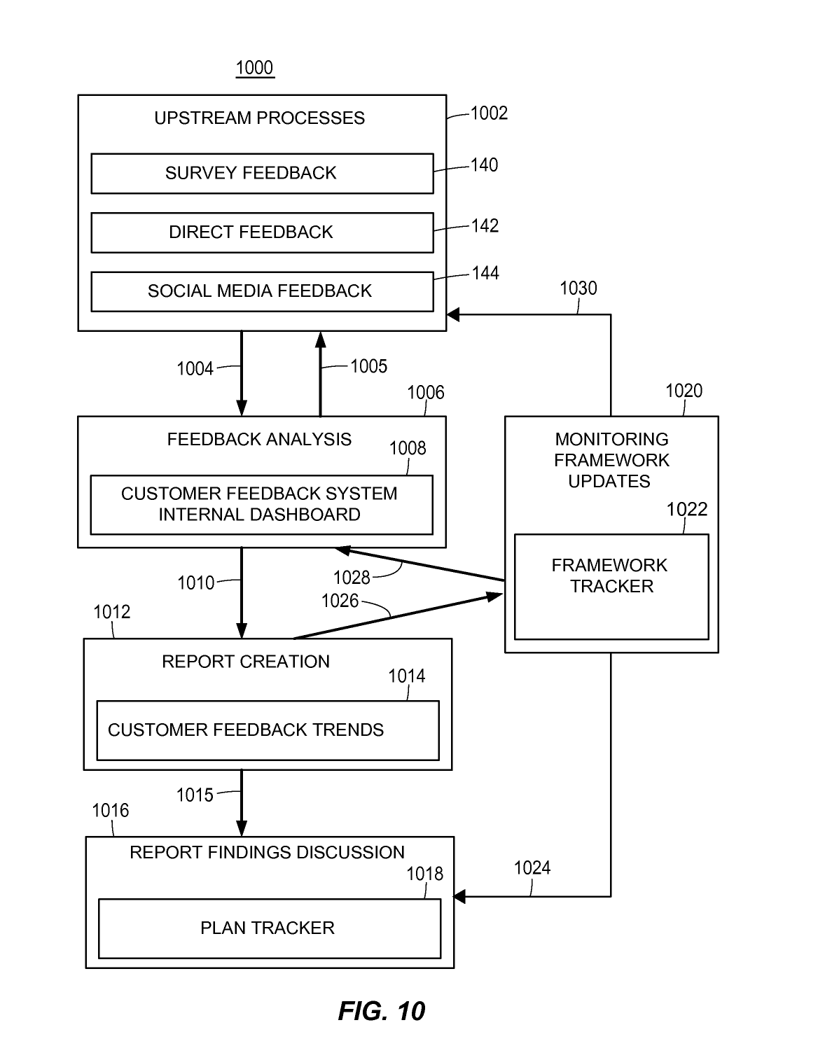

FIG. 10 is a diagram of the customer feedback process 1000 for an organization 101, according to one embodiment. The customer feedback process 1000 may be executed by customer feedback system 302. The customer feedback process 1000 includes several steps: upstream processes 1002, feedback analysis 1006, report creation 1012, report findings discussion 1016, and monitoring framework updates 1020. While FIG. 10 displays an example customer feedback process 1000 executed by customer feedback system 302, other customer feedback processes are possible. In some embodiments, customer feedback process 1000 includes more, fewer, and/or different steps than those shown in FIG. 10. In some embodiments, customer feedback process 1000 may be executed by the customer feedback system 302, a different system, the agents of organization 101, agents of another organization, or a combination of all the above.

Customer feedback process 1000 includes the step upstream processes 1002. Upstream processes 1002 may comprise several actions. These actions may include data gathering, data analysis, data correlation, parameter generation, parameter initialization, alerts generation, alerts transmission, data aggregation, and/or aggregated data transmission. Upstream processes 1002 may send and/or receive data from one or more different steps within a customer feedback process 1000.

In FIG. 10, upstream processes 1002 feedback is gathered about the organization 101. The gathered feedback includes survey feedback 140, direct feedback 142, and social media feedback 144. In some embodiments, the upstream processes 1002 may gather more, less, and/or different types of feedback from those displayed in FIG. 10.

The next action in upstream processes 1002 is an initial analysis of the gathered data to determine related data. Following this, upstream processes 1002 includes the actions of generating and initializing parameters for when alerts should be identified and transmitted. Also, upstream processes 1002 also includes the actions of generating and initializing parameters for when data gathered should be aggregated and transmitted. Next, alerts and aggregated data may then be transmitted (see 1004) from upstream processes 1002 to feedback analysis 1006. Additionally, upstream processes 1002 may receive data (see 1005, 1030) from feedback analysis 1006 (see 1005) and/or monitoring framework updates 1020 (see 1030).

Customer feedback process 1000 also includes the step feedback analysis 1006. Feedback analysis 1006 may include several actions and send and/or receive data from one or more different steps within a customer feedback process 1000. Feedback analysis 1006 initiates actions to spot key issues, significant trends, and prioritize work. Feedback analysis 1006 also initiates an action to determine if upstream processes 1002 needs to conduct more analysis.

In FIG. 10, a customer feedback system internal dashboard 1008 is used to carry out the actions of feedback analysis 1006. Feedback analysis 1006 receives inputs from upstream processes 1002 (such as alerts and aggregated data) along with updates from monitoring framework updates 1020. The received inputs are incorporated into the customer feedback system internal dashboard 1008. As a result, the displayed received inputs on the customer feedback system internal dashboard 1008 enable the organization 101 to determine key issues and trends and what work to prioritize. These results are then transmitted (1010) to report creation 1012. Additionally, the customer feedback system internal dashboard 1008 enables the organization 101 to determine if additional analysis is needed from upstream processes 1002. If so, an output is transmitted (1005) to upstream processes 1002. In some embodiments, the feedback analysis 1006 initiates the above actions without using a customer feedback system internal dashboard.

Another step of customer feedback process 1000 is report creation 1012. Report creation 1012 may include several actions and send and/or receive data from one or more different steps within a customer feedback process 1000. Report creation 1012 focuses on several actions, including creating reports for a specific audience, contributing to various research reports, creating reports for ongoing reporting items, and/or including I&C touchpoints. Report creation 1012 achieves the above actions by using customer feedback trends 1014. However, in some embodiments, report creation 1012 may achieve the above actions without customer feedback trends 1014. Report creation 1012 receives inputs (see 1010) from feedback analysis 1006 and sends outputs (see 1015, 1026) to report findings discussion 1016 (see 1015) and monitoring framework updates 1020 (see 1026).

The customer feedback process 1000 also includes report findings discussion 1016. Report findings discussion 1016 may include several actions and send and/or receive data from one or more different steps within a customer feedback process 1000. Report findings discussion 1016 involves actions such as continuously discussing observed trends with key stakeholders, encouraging progress towards an action plan to improve customer experience, and including research and monitoring touch points. Report findings discussion 1016 uses a plan tracker 1018 to execute the above actions. The plan tracker may be one of or a combination of a spreadsheet, word processing document, slide deck, list, chart, table, software file, hardcopy, and/or some other mechanism for tracking a plan. However, in some embodiments, report findings discussion 1016 may achieve the above actions without using a plan tracker 1018. Report findings discussion 1016 receives inputs (see 1015) from report creation 1012 and sends outputs (see 1024) to monitoring framework updates 1020.

The monitoring framework updates 1020 step is also part of the customer feedback process 1000. Monitoring framework updates 1020 may include several actions and send and/or receive data from one or more different steps within a customer feedback process 1000. Monitoring framework updates 1020 initiates actions such as developing and testing models to provide early identification of problems, identifying alerts to set, and updating the customer feedback system internal dashboard 1008. Monitoring framework updates 1020 relies on a framework tracker 1022 to accomplish the above actions. The framework tracker 1022 tracker may be one of or a combination of a spreadsheet, word processing document, slide deck, list, chart, table, software file, hardcopy, and/or some other mechanism for tracking a plan and/or framework. However, in some embodiments, monitoring framework updates 1020 does not use a framework tracker 1022 to achieve the above actions. Monitoring framework updates 1020 receives inputs (see 1026, 1024) from report creation 1012 (see 1026) and report findings discussion 1016 (see 1024). Also, monitoring framework updates 1020 sends outputs (see 1028, 1030) to feedback analysis 1006 (see 1028) and upstream processes 1002 (see 1030).

In some embodiments, the steps of customer feedback process 1000 (upstream processes 1002, feedback analysis 1006, report creation 1012, report findings discussion 1016, and monitoring framework updates 1020) may contain more, fewer, and/or different actions than those described above for FIG. 10. Additionally, one or more of these steps may send data to and/or receive data from more, fewer, and/or different steps of the customer feedback process 1000 than those described above. Further, one or more of the steps may be implemented by the customer feedback system 302, a different system, the agents of organization 101, agents of another organization, or a combination of all the above.

### Customer Feedback Process Example

Upstream processes 1002 may involve gathering multiple feedback items. The feedback items may include survey feedback 140, direct feedback 142, and social media feedback 144. The upstream processes 1002 may then include analyzing the gathered feedback data and determining some of the survey feedback 140, direct feedback 142, and social media feedback 144 is related. The feedback may be related because they are all negative feedback items about a product from the organization 101, such as an auto insurance policy.

Next, the upstream processes 1002 may initiate actions to set parameters for alerting and data aggregation. For example, an alerting threshold parameter of three or more related negative feedback items may be set to generate an alert. Additionally, a data aggregation threshold of three or more alerts may be set to aggregate and send the data causing the alerts. The alerts and aggregated data may be sent (see 1004) to a customer feedback system internal dashboard 1008 for further analysis as part of the customer feedback process.

After receiving the alerts and aggregated data, feedback analysis 1006 may initiate an update of the customer feedback system internal dashboard 1008 based on the alerts and aggregated data. The updated customer feedback system internal dashboard 1008 may provide insights on key issues, key trends, and work to prioritize. For example, the received alerts and aggregated data regarding negative feedback about an auto insurance policy may populate the customer feedback system internal dashboard 1008 in a way to reveal key issues and trends with that auto insurance policy. As a result, feedback analysis 1006 may encourage prioritization of work to improve the auto insurance policy. Feedback analysis 1006 may then forward these trends to report creation 1012 (see 1010). Additionally, if further analysis about the auto insurance policy was needed, feedback analysis 1006 could send an output to upstream processes 1002 requesting further analysis of data regarding the auto insurance policy.

Once report creation 1012 receives trend data about the auto insurance policy from feedback analysis 1006 (see 1010), updates can be done for ongoing reporting items, such as products to improve, to include the defective auto insurance policy. Additionally, report creation 1012 can include generating reports about the defective auto insurance policy for a specific audience, such as managers and executives responsible for the performance of the auto insurance policy. Also, the auto insurance policy trend data can be used for other research reports generated. Reports generated based on the auto insurance trend data may be sent to one or both of report findings discussion 1016 (see 1015) and monitoring framework updates 1020 (see 1026).

Once report findings discussion 1016 receives reports about the auto insurance policy from report creation 1012 (see 1015), an action plan may be generated and/or updated to improve the customer experience regarding the auto insurance policy. A plan tracker may be generated and/or used to determine improvements of the customer experience regarding the auto insurance policy. Continuous discussion of the auto insurance policy trends with key stakeholders, such as managers and executives, may also be encouraged via the plan tracker. The plan tracker may also include research and monitoring touchpoints, The plan tracker 1018 may capture the results of these discussions, which may then be forwarded to monitoring framework updates 1020 (see 1024).

Monitoring framework updates 1020 uses a framework tracker 1022 to improve monitoring framework. Monitoring framework updates 1020 develops and tests models to provide early identification of problems. If improvements to the models are determined, monitoring framework updates 1020 can send these improvements to upstream processes 1002 (see 1030). For example, thresholds for alerting and data aggregation may be reduced to identify problems with products earlier. Specifically, problems with an auto insurance policy may be determined earlier by generating alerts after two negative feedback items and also by aggregating and sending data after two alerts. These threshold reductions would be sent from the monitoring framework updates 1020 to upstream processes 1002 (see 1030) to modify the parameters for generating and transmitting alerts and aggregating and sending data.

Additionally, monitoring framework updates 1020 may transmit updates for the customer feedback system internal dashboard 1008 to feedback analysis 1006 (see 1028). For example, the reduction of negative feedback items required for alerting from 3 to 2 and alerts required for data aggregation and transmission from 3 to 2 may require the customer feedback system internal dashboard 1008 to be updated. Specifically, customer feedback system internal dashboard 1008 may need to be updated to increase the level of prioritization of work to improve the auto insurance policy. This update would be sent from monitoring framework updates 1020 to feedback analysis 1006 (see 1028) to update the customer feedback system internal dashboard 1008. By executing the various steps of the customer feedback process 1000, the customer feedback system 302 may improve customer experience more efficiently.

### Customer Feedback System Methods

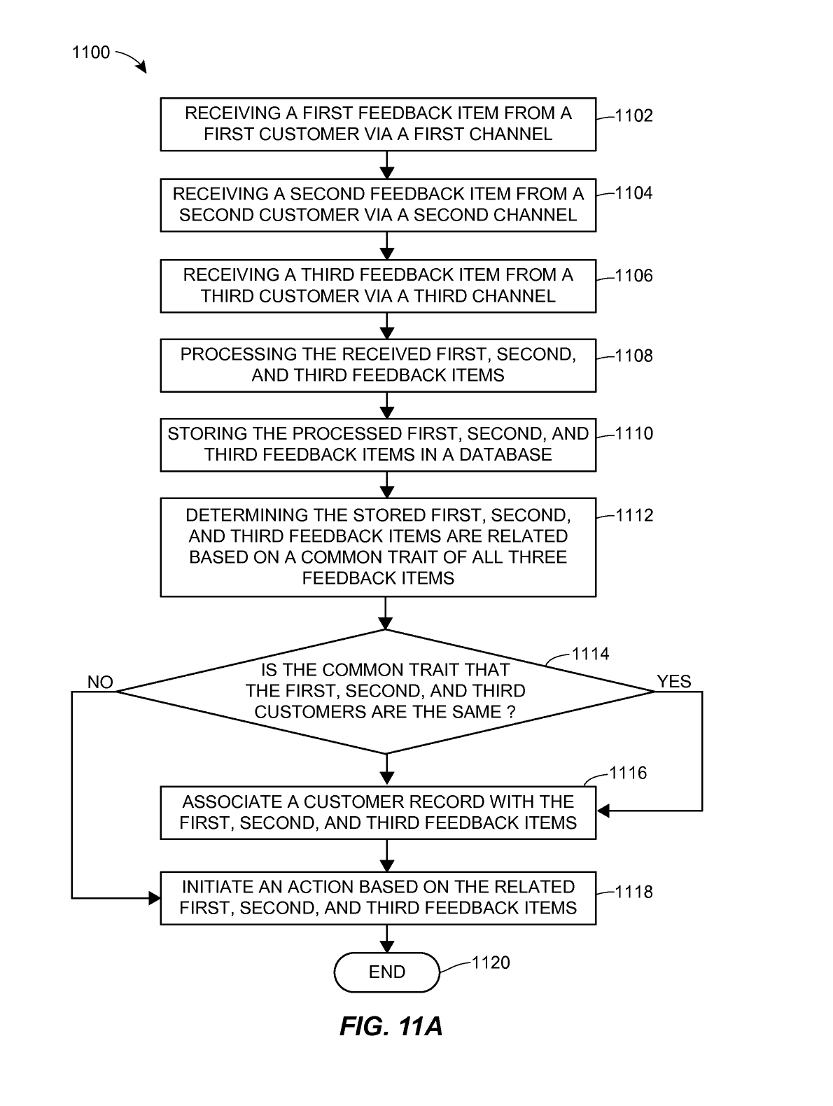

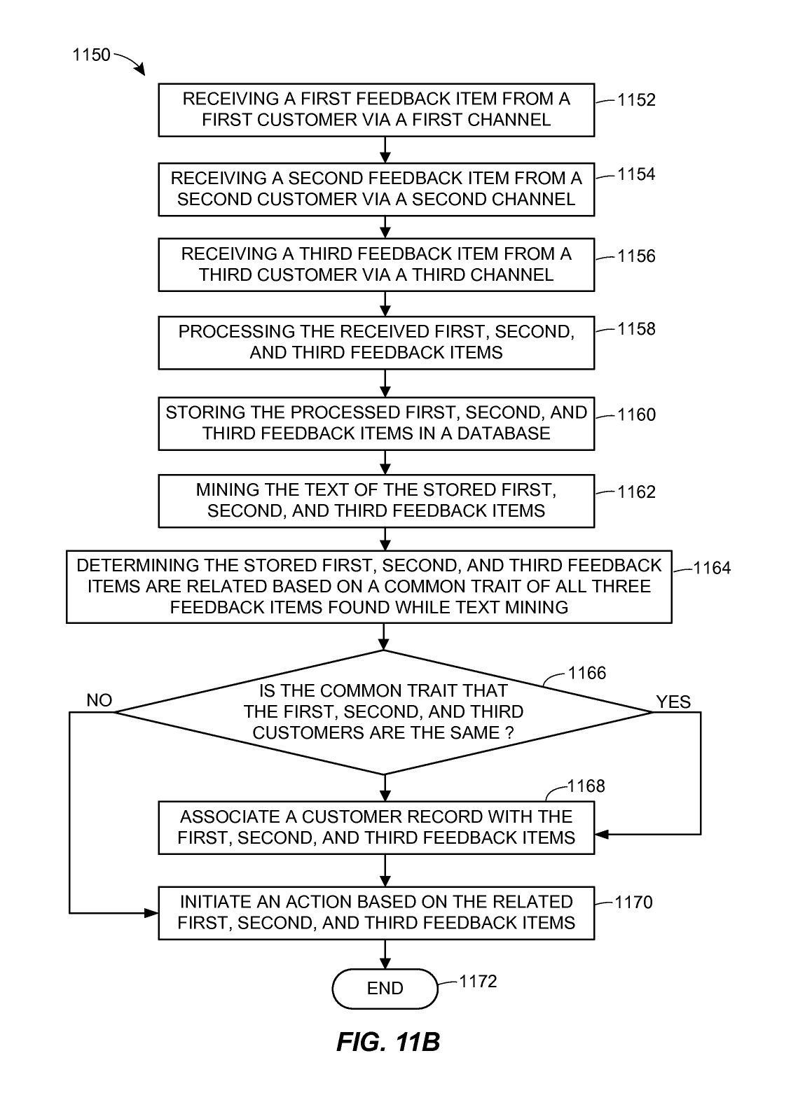

FIG. 11A is a diagram of an example method 1100 for a customer feedback system. The system receives a first feedback item from a first customer via a first channel (block 1102). Next, the system receives a second feedback item from a second customer via a second channel (block 1104). After that, the system receives a third feedback item from a third customer via a third channel (block 1106). The system then processes the received first, second, and third feedback items (block 1108). Next, the system stores the processed first, second, and third feedback items in a database (block 1110). After that, the system determines the stored first, second, and third feedback items are related based on a common trait of all three feedback items (block 1112).

Next, the system answers the question of whether the common trait held by the three feedback items is that the first, second, and third customers are the same customer (block 1114). If the answer is “NO”, the system proceeds to block 1118. If the answer is “YES”, then the system proceeds to block 1116. The system associates a customer record with the first, second, and third feedback items (block 1116). After this, the system proceeds to block 1118.

The system initiates an action based on the related first, second, and third feedback items (block 1118). Once the action is initiated, the method is complete (block 1120). In some embodiments, the method 1100 includes more steps than those displayed in FIG. 11A, while in other embodiments, the method 1100 includes fewer steps than those displayed in FIG. 11A. In some embodiments, the method 1100 includes the displayed steps arranged in a different order than the order shown in FIG. 11A.

FIG. 11B is a diagram of an example method 1150 for a customer feedback system. The system receives a first feedback item from a first customer via a first channel (block 1152). Next, the system receives a second feedback item from a second customer via a second channel (block 1154). After that, the system receives a third feedback item from a third customer via a third channel (block 1156). The system then processes the received first, second, and third feedback items (block 1158). Next, the system stores the processed first, second, and third feedback items in a database (block 1160). The system then mines the text of the stored first, second, and third feedback items to determine traits of the stored first, second and third feedback items (block 1162). After that, the system determines that the stored first, second, and third feedback items are related based on a common trait of all three feedback items (block 1164).

Next, the system answers the question of whether the common trait held by the three feedback items is the first, second, and third customers are the same customer (block 1166). If the answer is “NO”, the system proceeds to block 1170. If the answer is “YES”, then the system proceeds to block 1168. The system associates a customer record with the first, second, and third feedback items (block 1168). After this, the system proceeds to block 1170.

The system initiates an action based on the related first, second, and third feedback items (block 1170). Once the action is initiated, the method is complete(block 1172). In some embodiments, the method 1150 includes more steps than those displayed in FIG. 11B. In some embodiments, the method 1150 includes fewer steps than those displayed in FIG. 11B. In some embodiments, the method 1150 includes the displayed steps arranged in a different order than the order shown in FIG. 11B.

### Conclusion

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

1. A computer system comprising:
a processor; and
a program memory storing executable instructions that when executed by the processor cause the computer system to:
receive a first feedback item from a first customer via a first channel,
wherein the first feedback item is a social media message, customer complaint, or a customer response,
wherein the first channel is a social media website or a social media system;
receive a second feedback item from a second customer via a second channel,
wherein the second feedback item is a solicited response to a customer survey provided by an organization to a customer,
wherein the second channel is a phone call, email, letter, website, meeting, conversation, fax, or text message, wherein the website is not a social media website,
wherein the first channel is different from the second channel;
process the first feedback item;
process the second feedback item;
determine the first feedback item and second feedback item are related; and
initiate an action based on the related first feedback item and second feedback item.

2. (canceled)

3. The system of claim 1, wherein the processor further causes the computer system to:
store the received first and second feedback items in a feedback database; and
mine text of the stored first and second feedback items in the feedback database to determine traits of the stored first and second feedback items.

4. The system of claim 3, wherein the action is initiated because the related first and second feedback items exceed a predetermined threshold.

5. A method for integrating multiple feedback items to improve an organization comprising:
receiving a first feedback item from a first customer via a first channel,
wherein the first feedback item is a social media message,
wherein the first channel is a social media website_or a social media system;
receiving a second feedback item from a second customer via a second channel,
wherein the second feedback item is a solicited response to a customer survey provided by an organization to a customer,
wherein the second channel is a phone call, email, letter, website, meeting, conversation, fax, or text message, wherein the website is not a social media website;
processing with a processor the first feedback item;
processing with the processor the second feedback item;
determining with the processor the first feedback item and second feedback item are related; and
initiating with the processor an action based on the related first feedback item and second feedback item.

6. (canceled)

7. The method of claim 5, wherein the common trait of the first and second feedback items is that the first and second customers are a same customer of an organization, wherein the method further comprises associating a customer record of the same customer with the first and second feedback items.

8. The method of claim 5, wherein the common trait of the first and second feedback items is a same topic, wherein the topic is a weather related event.

9. A method for integrating multiple feedback items from one or more customers to improve an organization that engages with one or more customers comprising:
receiving a first feedback item from a first customer via a first channel,
wherein the first feedback item is a solicited response to a customer survey provided by the organization to the first customer, wherein the first channel is an email;
receiving a second feedback item from a second customer via a second channel,
wherein the second feedback item is a complaint, wherein the second channel is a phone call;
receiving a third feedback item from a third customer via a third channel,
wherein the third feedback item is a message, wherein the third channel is a social media website;
processing with a computer processor the first feedback item;
storing the first feedback item in a feedback database;
processing with the computer processor the second feedback item;
storing the second feedback item in the feedback database;
processing with the computer processor the third feedback item;
storing the third feedback item in the feedback database;
determining the first feedback item, second feedback item, and third feedback item are related based on a common trait of all three feedback items; and
initiating with the computer processor an action based on the related first feedback item, second feedback item, and third feedback item.

10. The method of claim 9, wherein the common trait of all three feedback items is that the first customer, second customer, and third customer are all a same customer of an organization, wherein the method further comprises associating a customer record of the same customer with the first, second, and third feedback items.

11. The method of claim 9, wherein the common trait of all three feedback items is a same topic.

12. The method of claim 11, wherein the topic is a weather related event, such as an earthquake, hurricane, tornado, typhoon, tidal wave, blizzard, storm, hailstorm, monsoon, flood, or fire.

13. The method of claim 11, wherein the topic is a product, service, or marketing materials provided by an organization to one or more customers.

14. The method of claim 9 further comprising:
mining text of the stored first, second, and third feedback items in the feedback database to determine traits of the stored first, second, and third feedback items.

15. The method of claim 9, wherein the action is initiated because the related first, second, and third feedback items exceed a predetermined threshold.

16. The method of claim 15, wherein a weight can be assigned to the first, second, and third feedback items to determine if the first, second, and third feedback items exceed the predetermined threshold.

17. The method of claim 10, wherein the initiated action includes alerting a part of the organization to contact the customer to retain the customer.

18. The method of claim 13, wherein the initiated action includes trending feedback about the product, service, or marketing materials to determine how to improve the product, service, or marketing materials based on the trended feedback.

19. The method of claim 13, wherein the initiated action includes reporting to a part of the organization updated, near real-time data about the product, service, or marketing materials.

20. The method of claim 9 further comprising:
performing a voice analysis of the second feedback item to determine a stress level; and
updating the stored second feedback item in the feedback database to include the determined stress level.

21. The method of claim 9, wherein the common trait is a vehicle insurance policy provided by the organization to customers, wherein the first, second, and third customers are different customers.

22. The method of claim 21, wherein the second feedback item is an unsolicited complaint by the second customer to the organization.
